(19) United States
(12) Patent Application Publication
(10) Pub. No.: US 2012/0073417 A1
(43) Pub. Date: Mar. 29, 2012

(54) Method and Device for Cutting a Sheet Material

(75) Inventors: Kenji Ujiie, Matsusaka-shi (JP); Koji Tamai, Mie (JP); Chikao Nakashima, Mie (JP)

(73) Assignee: Central Glass Company, Limited, Ube-shi, Yamaguchi (JP)

(21) Appl. No.: 13/376,786

(22) PCT Filed: Jun. 2, 2010
(86) PCT No.: PCT/JP2010/059367

§ 371 Date: Dec. 7, 2011

(30) Foreign Application Priority Data
Jun. 15, 2009 (JP) 2009-142015

(51) Int. Cl. B26D 7/32; B26D 7/01; B26D 7/20; B26D 1/45

(52) U.S. Cl. 83/24; 83/454; 83/98; 83/13

(57) ABSTRACT

[Task] A sheet material is cut in a predetermined closed loop shape.

[Means for solving task]

A cutting apparatus for a sheet material, comprises: an air table which is capable of ejecting or sucking air through a plurality of minute punching sections thereof; a template having at least one recess groove section in a predetermined closed loop shape mounted and fixed onto the air table and a punching section located at each of positions on the template which is coincident with a position of each of the punching sections of the air table; a cutter blade disposed on an upper position of the sheet material mounted on the template to cut the sheet material along the recess groove section of the template; and cutter blade driving means which is capable of moving and rotating the cutter blade in X, Y, and Z coordinate axes.

### TECHNICAL FIELD

The present invention relates to method and apparatus for cutting an intermediate film to be used for a laminated glass for use in a side windshield of an automotive vehicle to conform to a shape of a glass plate of the side windshield.

### BACKGROUND ART

From among laminated glasses in which a plurality of sheets of glass plates are laminated and adhered onto one another, most known and widely used laminated glass is the laminated glass in which a resin sheet made of poly vinyl butyral (PVB) are inserted and adhered as the intermediate film.

In a case where the laminated glass used for a front windshield or rear windshield of the automotive vehicle is manufactured, the intermediate film is stretched to a sector shape and is cut so as to conform to the sector shape of the front windshield or the rear windshield. Hence, the intermediate film after the cut will shrink with a lapse of time. Therefore, it is necessary to cut the intermediate film with a slightly larger size than the windshield size and to cut a protruded portion of the intermediate film after the heat and adherence away from a non-protruded portion by means of a razor.

On the other hand, in a case where a glass having a relatively large bending curvature (radius of curvature) such as the side windshield of the automotive vehicle or the laminated glass having a flat shape is manufactured, the glass is cut with a flat intermediate film unchanged without shaping to the sector shape. Hence, the shrinkage after the cut is small. As a technique to cut such a sheet-like work to a desired shape, such a method that the sheet-like work mounted on a surface plate is sequentially cut with a cutter blade along a line which coincides with a desired outer shape or such a method as a whole periphery of the work is simultaneously pressed and punched with a blade mold is known.

A Japanese Patent Application First Publication No. (tokkai) 2000-119950 exemplifies a previously proposed cutting apparatus for a sheet material which comprises: a supporting table (2) having a breathability and which is supportable in an expanded state of the sheet material and which is capable of supporting the sheet material (W) in an expanded state of the sheet material; a cutting head (3) located at an upper part of the supporting table (2) and having a cutting portion (17) directed toward a lower direction; an absorbing head (4) disposed at a lower portion of the supporting table to correspond to the cutting head (3) with an absorbing surface (30) oriented toward an upper portion; and head movement means (5) for plane moving synchronously the cutting head (3) and the absorbing head (4) at an upper-and-lower portion thereof by which the supporting table (2) is sandwiched, the cutting head (3) directly cutting the sheet material (W) on the supporting table (2) (Patent Document 1).

A Japanese Patent Application First Publication No. Heisei 8-188433 exemplifies a previously proposed numerical value control cutting apparatus 1 for a glass plate comprising: a bridge frame 4 having X direction direct driving means 3 for directly driving a cutter head 2 in an X axis direction and supported so as to be movable in an Y axis direction with both side sections 5, 6 thereof; ball screw nuts 7,8 rotatably attached onto both side sections 5,6 of the bridge frame 4; ball screws 9, 10 extended in the Y direction onto which respective ball screw nuts 7,8 are screwed; Y direction direct driving means 11 for synchronously rotating both of ball screws nuts 7, 8 to directly drive bridge frame 4 in the Y direction; another ball screw nut 13 rotatably attached onto the X direction direct driving means 3 to be screwed onto the other ball screw 12, wherein the X direction direct driving means 3 causes the other ball screw nut 13 to be rotated so that the cutter head 2 is directly driven in the X direction (Patent Document 2).

Furthermore, a Japanese Utility Model Registration Application Publication No. Heisei 6-016435 exemplifies a previously proposed cutting apparatus for a glass plate comprising: an air table which supports the glass plate in a forward-and-backward direction of a roll conveyor; a catcher tank located at a lower side between rolls of the roll conveyor; a nozzle which can run freely along a laterally extended rail over an upper part of the tank; traveling means for forwardly-and-backwardly moving the glass plate adjoined to one sides of the roll conveyer and air table; a plurality of arms projected from the traveling means onto the roll conveyer and the air table; sticking pads disposed on a tip portion of the arms to support the glass plate (Patent document 3).

### PRE-PUBLISHED DOCUMENT

### Patent document

Patent document 1: Japanese Patent Application First Publication (tokkai) No. 2000-119950
Patent document 2: Japanese Patent Application First Publication (tokkai) No. Heisei 8-188433
Patent document 3: Japanese Utility Model Registration Application Publication (Jikkai) No. Heisei 6-16435

### DISCLOSURE OF THE INVENTION

### Task to be Solved by the Invention

Patent document 1 describes the sheet material on the supporting table in which a sponge-like elastic layer material such as a thin carpet or a rubber is mounted on a groundwork plate of a metallic plate having a porosity structure, mesh structure, or so forth. Patent document 2 describes that the sheet material is strongly pressured to make the cutter installed above the sheet material cut the sheet material with the cutter pressed against the supporting table until the sheet material is completely separated. Hence, at the same time when the cut of the sheet material by means of the cutter is carried out, the elastic layer material and the metallic groundwork plate are slidably contacted on each other. A wear out of the tip portion of the cutter due to repetitive cuts and a cut failure due to convexes and recesses due to flaws on the surface of the elastic layer material are resulted and there is a problem of giving an ill influence on a quality of product due to an adhesion of dust on the elastic layer material.

In addition, since the absorbing head installed on the lower part of supporting table is plane moved in synchronization with the cutting head which is plane moved on the upper part of supporting head, only a part of the sheet material is fixed but the whole part of the sheet material is not fixed. Therefore, the sheet material is shifted during the breakage so that there is a possibility of not providing a desired shape for the broken size of sheet material.

The invention described in Patent Document 2 gives a cutting line for the cutting purpose on an upper surface of the glass plate by means of the cutter which can move the glass plate having a brittleness mounted on the table in the X and Y directions. Since the surface of the glass plate is hard, there is no case where the cutter arrives at the table surface when the cutter gives the cutting line on the glass plate and no flaws are given. However, in a case where, in place of the glass plate, a soft sheet material such as the intermediate film for the purpose of the laminated glass is cut, the present invention cannot be applied.

In addition, according to the invention described in Patent Document 3, the glass plate which becomes float by means of the air table is advanced or retracted and the water jet is ejected so that the glass plate is cut. Therefore, there is no problem for the cut of the sheet material which is strong in water such as the glass plate but the sheet material whose quality is changed according to the moisture such as a poly vinyl butyral (PVB film) used as the intermediate film of the laminated glass.

### Means for Solving the Task

It is, hence, an object of the present invention to provide cutting method and apparatus for a sheet material which are capable of cutting a soft sheet material such as a resin intermediate film without contact of the blade section of the cutter to the table and cutting the sheet material to a desired shape without generation of a cut failure, when the resin intermediate film for the laminated glass is cut.

That is to say, a cutting apparatus for a sheet material according to the present invention comprising: an air table which is capable of ejecting or sucking air through a plurality of minute punching sections thereof; a template having at least one recess groove section in a predetermined closed loop shape mounted and fixed onto the air table and a punching section located at each of positions on the template which is coincident with a position of each of the punching sections of the air table; a cutter blade disposed on an upper position of the sheet material mounted on the template to cut the sheet material along the recess groove section of the template; and cutter blade driving means which is capable of moving and rotating the cutter blade in X, Y, and Z coordinate axes.

Or, in the cutting apparatus for the sheet material according to the present invention, a plurality of recess groove sections, each of the recess groove sections having mutually the same shape or having a different shape from one another, are juxtaposed or intersected on the template.

Or, in the cutting apparatus for the sheet material according to the present invention, carrying in-and-out means for carrying in and out the sheet material onto and from the air table are provided.

Or, in the cutting apparatus for the sheet material according to the present invention, a width of the recess groove section on the template ranges from 2 to 7 mm and a depth thereof is equal to or longer than 2 mm.

Or, in a cutting method for the sheet material is according to the present invention, in the cutting method for the sheet material using any one of the apparatuses described above, comprising: fixedly overlapping the template on the air table such that the position of each punching section of the air table is made coincident with that of each of the punching sections of the template; and cutting the sheet material with the cutter blade when a tip portion of the cutter blade during the cutting is slipped in the recess groove section of the template in a state in which the sheet material mounted on the template is attracted and fixed on the template by means of a suction of the air table.

Or, in the cutting method for the sheet material according to the present invention, the sheet material is cut in such a way that the tip portion of the cutter blade moved in the recess groove section is slipped in the recess groove section by 1 mm or longer from an uppermost surface of the recess groove section.

Or, in the cutting method for the sheet material according to the present invention, in a case where the sheet material is carried in or out to or from the template, a terminal section of the sheet material is attracted and fixed on a sticking pad and, while air is ejected through the punching sections of the air table to make the sheet material in a float state, the sheet material is carried and moved.

### Effect of the Invention

According to the present invention, since the template having at least one recess groove section in the closed loop along the cut shape of the sheet material is detachably mounted on the air table, the blade section of the cutter goes through the sheet material but is rested within the recess groove section so as not to be contacted on the air table in a case where the cutter cuts the soft material such as the resin intermediate film.

Thus, since the sheet material can be cut without contact of the blade section of the cutter on the air table, the wear out of the cutter blade is minor. Thus, the cut failure due to the wear out can remarkably be reduced with a long span of life.

In addition, since the sheet material is cut along the recess groove section by means of the cutter in the state in which the whole sheet material is adsorbed and fixed through the punching sections, the failure in the cutting size due to a positional shift error of the sheet material does not occur.

### BRIEF DESCRIPTION OF THE DRAWINGS

FIG. 1 is a rough perspective view of a cutting apparatus in a first preferred embodiment according to the present invention.

FIG. 2 is a plan view of a template of the cutting apparatus in the first preferred embodiment according to the present invention.

FIG. 3 is a partial cross sectional view of the cutting apparatus in the fist preferred embodiment according to the preset invention.

FIG. 4 is a plan view of the template of the cutting apparatus in a second preferred embodiment according to the present invention.

FIG. 5 is a plan view of the template of the cutting apparatus in a third preferred embodiment according to the present invention.

FIG. 6 is a plan view of the temperate of the cutting apparatus in a fourth preferred embodiment according to is the present invention.

### DESCRIPTION OF THE EMBODIMENTS

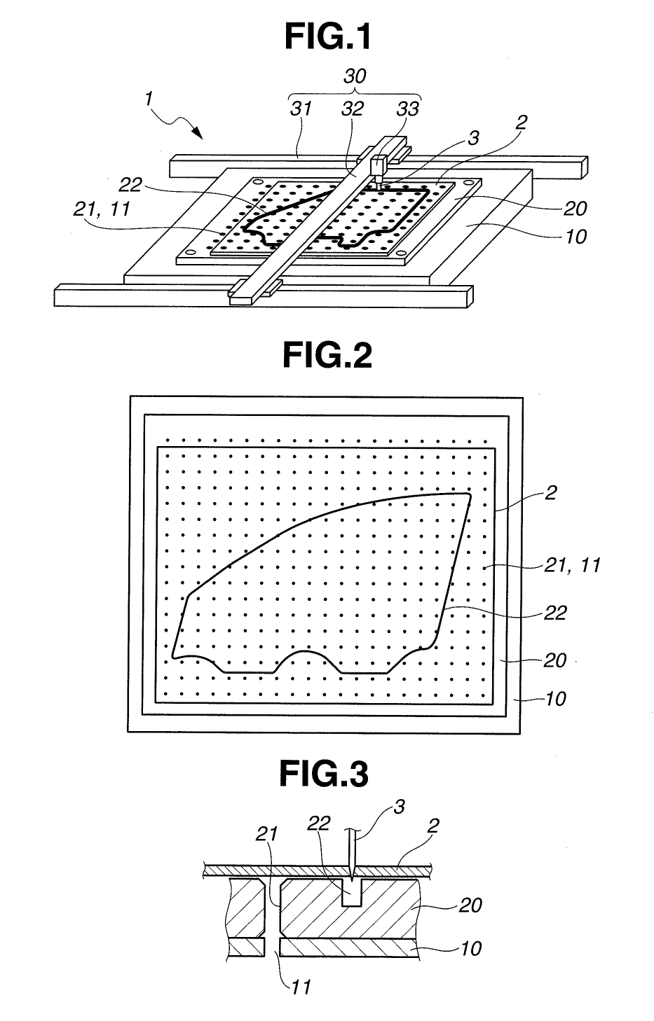

As shown in FIGS. 1 through 3, a cutting apparatus 1 for a sheet material according to the present invention includes: an air table 10 which is capable of ejecting or sucking air through a plurality of minute punching sections 11, 11, . . . ; a template 20 having a recess groove section 22 in a predetermined closed loop fixedly mounted on air table 10 and a punching section 21 at each position coincident with a position of each punching section 21 of air table 10; and cutter blade driving means 30 disposed at an upper position of sheet material 2 mounted on template 20 and which is capable of moving and rotating cutter blade 3 to cut sheet material 2 along recess groove section 22 of template 20 through XYZ-θ axes.

Air table 10 is of a shape of a chamber having an inner part in which a cavity space is provided having a plurality of infinite number of minute punching sections 11, 11, 11, . . . on the upper surface of air table 10, a compression air is supplied within the chamber during a transportation of sheet material 2 to and from air table 10 to eject the compression air through punching sections 11, 11, . . . , and transported in or from air table 10 while sheet material 2 is made float.

On the other hand, if the air within chamber is sucked by means of a vacuum pump or so forth (not shown) within chamber to provide a negative pressure within the chamber, the air between air table 10 and sheet material 2 is sucked into the chamber through punching sections 11, 11, . . . . Consequently, sheet material 2 is attracted onto an upper part of air table 10. In details, template 20 is interposed between air table 10 and sheet material 2. Hence, sheet material 2 is attracted onto air table 10 through punching sections 11, 11, . . . of air table 10 and punching sections 21, 21, . . . of template 20.

In addition, template 20 is plate-like shape made of resin. Template 20 has the same dimension as air table 10 or slightly smaller than air table 10. Template 20 is disposed to make a position of each of punching sections 21, 21, . . . installed on temperate 20 coincident with the position of each of punching sections 11, 11, . . . of air table 10. With a positional shift of each of punching sections 21, 21, . . . taken into consideration, each hole diameter of punching sections 21, 21, . . . , at template side is slightly larger than each hole diameter of punching sections 11, 11, . . . of air table 10 and removably fixed onto air table 10.

Furthermore, at least one recess groove section 22 in a closed loop mounted on an upper surface of template 20 is a shape such that the closed loop shape constituted by a center line of recess groove section 22 coincides with a desired shape to which sheet material 2 is to be cut.

With a thickness of generally available cut blade 3 approximately 0.4 mm and with a thickness range thereof to be cut approximately from 0.1 to 0.5 mm dependent upon sheet material 2 to be cut taken into consideration, the width of recess groove section 22 of template 20 may be 2 through 7 mm and may have a depth of 2 mm or deeper. It is necessary to have a depth such that a tip portion of cutter blade 3 is not contacted on a bottom section of recess groove section 22 when cutter blade 3 goes through sheet material 2 and is inserted through a lower surface of sheet material 2 by 1 mm or longer.

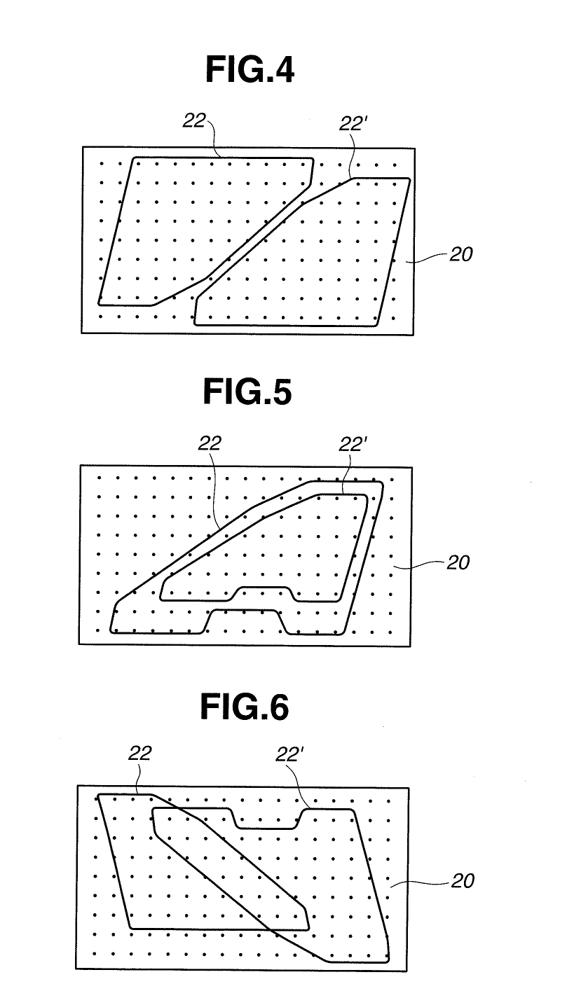

As shown in FIG. 4, a plurality of recess groove sections 22 in the closed loop of the same shape can be juxtaposed together on one sheet of template 20. In this case, it is possible to adopt a plurality of sheets of work from the same sheet material 2.

As shown in FIG. 5, a smaller sized recess groove section 22′ can be disposed within a larger sized recess groove section 22 on one sheet of template 20.

As shown in FIG. 6, a plurality of recess groove sections 22, 22′ having different shapes from one another may be disposed with intersections. In a case of FIGS. 5 and 6, the shape of any one of recess groove sections 22, 22′ may be selected and used.

Sheet material 2 onto air table 10 may be carried in or out by means of carrying in-and-out means.

As the carrying in-and-out means, air may be ejected through punching sections 11, 11, . . . of air table 10 such that sheet material 2 becomes slightly float and, in a state in which sheet material 2 is slightly float, both corner portions at the tip portion of sheet material 2 is absorbed and held by means of abruption pads and, at the same time, may move sheet material 2 by dragging sheet material 2.

Cutter blade driving means 30 includes: X axis driving means 31 according to the direct drive system in the X axis direction; Y axis driving means 32 according to the direct drive system in the Y axis direction; Z axis driving means 33 for elevating and lowering the cutting head having cutter blade 3 in a Z axis direction by means of air cylinder and motor; and θ axis driving means for rotating cutter blade 3 to always direct cutter blade 3 in a tangential direction at a curved section of a plane constituted by XY axes. An articulated robot may be used for the cutter blade driving means 30 constituted by these means.

As cutter blade 3, a single edge or double edge standard draw-cut cutter knife may be used. As the thickness of cutter blade 3, the thickness of generally available cutter blade is approximately 0.4 mm. The cutter blade having the thickness ranging from about 0.1 to 0.5 mm may be used.

The method of cutting sheet material 2 using cutting apparatus 1 as described before will be described below.

Template 20 is overlapped and fixed on air table 10 such that positions of a plurality of punching sections 11, 11, . . . installed at a constant interval on an upper side surface of air table 10 are coincident with those of a plurality of punching sections 21, 21, . . . installed at the constant interval on the plate-like template 20. In a state in which sheet material 2 mounted on template 20 is attracted and fixed according to a suction of sheet material 2 mounted on template 20, sheet material 2 is cut through cutter blade 3 in a state in which the tip portion of cutter blade 3 is slipped within the recess groove section 22 of template 20.

It should be noted that, although cutter blade 3 is used to cut the sheet material from a cut start position to a cut end position in a loop form, the stop position of the cut blade is not the same position as the cut start position. It is desirable that, if, with the cut end position overlapped on the cut start position by several millimeters, the sheet material is cut, string-like cut remains are eliminated.

The reason that template 20 having recess groove section 22 in the closed loop which is coincident with the cut shape is mounted on air table 10 is that a wear out of the blade section is suppressed in such a way that the blade section of cutter blade 3 which cuts sheet material 2 in the shape of the closed loop is not contacted on air table 10 and scraps other than sheet material 2 are not generated.

Sheet material 2 is cut in such a way that the tip section of cutter blade 3 which is to be moved within recess groove section 22 is slipped within recess groove 22 by being equal to or longer than 1 mm from an uppermost surface of recess groove section 22. That is to say, the tip portion of cutter blade 3 projected from a lower surface of sheet material 2 may, preferably, be 1 mm or longer.

If, at this time, cutter blade 3 is pressed on sheet material 2 when the tip portion of cutter blade 3 projected from the lower surface of sheet material 2 is shorter than 1 mm, a cutting failure often occurs due to a deflection of sheet material 2. Hence, the tip portion of cutter blade 3 penetrated through sheet material 2 is slipped within recess groove section 22 by a depth equal to or longer than 1 mm.

In a case where sheet material 2 is carried in or out over template 20, the tip portion of sheet material 2 or a tip corner section thereof is attracted by means of a small-diameter or elongated sticking pad not shown and air is ejected through punching sections 11, 11, . . . of air table 10 to make sheet material 2 in a float state.

Next, actions of cutting method for the sheet material and cutting apparatus therefor according to the present invention will be described below.

The reason that recess groove section 22 of the closed loop shape is provided on the upper surface side of template 20 and a shape of a center line of recess groove section is made coincident with the desired closed loop shape to be cut is that, when sheet material 2 is cut through cutter blade 3, the blade section of cutter blade 3 is not contacted on the upper surface of air table 10 so that the wear out of cutter blade 3 is not generated due to the contact of the blade section on air table 10 and cutting flaws are not developed on the upper surface of air table 10.

In addition, the reason that, when sheet material 2 is cut, sheet material 2 is attracted and fixed onto air table 10 according to the suction of air table 10 is that a cut shape failure does not occur according to no generation of a positional variation of sheet material 2 during the cutting of sheet material 2 and sheet material is tensed due to the attraction of sheet material 2 on air table 10. Thus, sheet material 2 cannot be deflected due to the attraction thereof toward the lower side through recess groove section 22. Consequently, a smooth cut of sheet material 2 can be preformed without occurrence of a cutting failure such as cat scraps or cutting irregularities which would occur when sheet material 2 is cut with cutter blade 2.

A plurality of recess groove sections 22 of the closed loop shape are provided on the one sheet of template 20 so that the number of templates 20 to be manufactured can be reduced.

The sheet material may be a sheet material made of a poly vinyl butyral (PVB film), a resin film, and so forth and which is used as the intermediate film of the laminated glass.

Next, usage examples of cutting apparatus 1 of the sheet material according to the present invention will be described below.

### Embodiment 1

As sheet material 2, the poly vinyl butyral film (PVB film) having the thickness of 0.7 through 1 mm was prepared.

As shown in FIG. 1, template 20 made of MC nylon resin is mounted on metallic air table 10 and bolts are used to fix four corner adjacent positions of template 20. Respective positions of air table 10 and template 20 are provided with punching sections 11, 21 of 2 mm φ for each pitch of 20 mm in both of longitudinal and lateral directions and are arranged so that the position of punching sections 11 of air table 10 are coincident with the position of punching section 21 of template 20.

As shown in FIGS. 2 and 3, recess groove sections 22 in the closed loop having the shape coincident with the shape of a side windshield of the automotive vehicle is disposed in a continued line shape. The width of recess groove section 22 is set to, for example, 2 mm and a depth thereof is set to, for example, 5 mm.

Sheet material 2 is carried in over template 20 fixed on air table 10 without wrinkle. During the carry in of sheet material 2, a positive pressure is applied within hollow chamber air table 10 to make sheet material 2 float and, when sheet material 2 is placed at a predetermined position of template 20, a negative pressure is switched to be applied within air table 10 so as to attract sheet material 2 onto template 20 and fixedly position sheet material 2 thereonto.

Cutter blade 3 installed on the upper position of sheet material 2 mounted on template 20 is moved by means of X-axis driving means 31 in the carrying direction Y-axis driving means 32 in the width direction, and Z-axis driving means 33 in vertical direction and is moved by means of cutter blade driving means 30 of XYZ-θ axes including arc shaped driving means which is rotatable the direction of the cutter blade at a portion of XYZ-θ axis plane which is curved in an arc shape on the XYZ-θ axis plane. Thus, sheet material 2 is cut along the center line of recess groove section 22 of template 20.

A traveling locus of cutter blade driving means 30 is stored to travel on the center line in the width direction of recess groove section 22 according to a previously teaching method and is not contacted on a wall surface of recess groove section 22.

After the completion of cutting, the tip corner sections of a surrounding portion of sheet material 2 were attracted and fixed with the sticking pad not shown and the tip portion of a part of sheet material 2 which was cut out in the shape of closed loop was attracted and held with the sticking pad not shown. Thereafter, sheet material 2 was made float with the pressure within air table 10 changed to the positive pressure. While an outside section of sheet material 2 was carried out to an exhaust box not shown, the outside section thereof was attracted and fixed with the sticking pad and the inside section of the closed loop curve was carried out to the subsequent process.

### Embodiment 2

As shown in FIG. 4, a plurality of recess groove sections 22, 22′ of the same shape are juxtaposed to one another within a single sheet of template 20. Otherwise, the same structure is taken as embodiment 1. Thus, sheet material 2 can be obtained which is cut in plural sheets in the closed loop having the predetermined shape from the single sheet material 2.

After cut sheet material 2 obtained through the plurality of recess groove sections 22, 22′ is carried out for each sheet of sheet material after the cut by the number of plurality of recess groove sections 22, 22′ within the template.

### Embodiment 3

As shown in FIG. 5, recess groove section 22 of the closed loop shape having the larger shape and recess groove section 22′ in the closed loop having the smaller shape are provided within single template 20. These sections are not used at the same time. One of recess groove sections 22, 22′ of the closed loop disposed on template 20 which is desired one is used. Otherwise, embodiment 2 is the same as the first embodiment. Thus, one sheet of the sheet material cut in the closed loop of the predetermined shape can be obtained from one sheet material.

### Embodiment 4

As shown in FIG. 6, recess groove section 22 in the closed loop shape and recess groove section 22′ in the closed loop, each recess groove section 22, 22′ having different shapes from each other, are provided within single sheet of template 20 so as to be intersected with each other. These sections are not used at the same time. One of recess groove sections 22, 22′ of the closed loop disposed on template 20 which is a desired one is used. Otherwise, embodiment 2 is the same as the first embodiment. Thus, one sheet of sheet material cut in the closed loop of the predetermined shape can be obtained from one sheet material.

### EXPLANATION OF SIGNS

1 cutting apparatus
2 sheet material
3 cutter blade
10 air table
11 punching section
20 template
21, 22′ punching section
30 cutter blade driving means
31 X axis driving means
32 Y axis driving means
33 Z axis driving means

1. A cutting apparatus for a sheet material, comprising:
an air table which is capable of ejecting or sucking air through a plurality of minute punching sections thereof;
a template having at least one recess groove section in a predetermined closed loop shape mounted and fixed onto the air table and a punching section located at each of positions on the template which is coincident with a position of each of the punching sections of the air table;
a cutter blade disposed on an upper position of the sheet material mounted on the template to cut the sheet material along the recess groove section of the template; and
cutter blade driving means which is capable of moving and rotating the cutter blade in X, Y, and Z coordinate axes.

2. The cutting apparatus for the sheet material as claimed in claim 1, wherein a plurality of recess groove sections, each of the recess groove sections having mutually the same shape or having a different shape from one another, are juxtaposed or intersected on the template.

3. The cutting apparatus for the sheet material as claimed in claim 1, which further comprises carrying in-and-out means for carrying in and out the sheet material onto and from the air table.

4. The cutting apparatus for the sheet material as claimed in claim 1, wherein a width of the recess groove section on the template ranges from 2 to 7 mm and a depth thereof is equal to or longer than 2 mm.

5. A method of cutting a sheet material using a cutting apparatus for the sheet material, comprising:
fixedly overlapping a template on an air table such that a position of each punching section of the air table is made coincident with that of each of punching sections of the template; and
cutting the sheet material with a cutter blade when a tip portion of the cutter blade during the cutting is slipped in a recess groove section of the template in a state in which the sheet material mounted on the template is attracted and fixed on the template by means of a suction of the air table.

6. The method for cutting the sheet material as claimed in claim 5, wherein the sheet material is cut in such a way that the tip portion of the cutter blade moved in the recess groove section is slipped in the recess groove section by 1 mm or longer from an uppermost surface of the recess groove section.

7. The method for cutting the sheet material as claimed in claim 5, wherein, in a case where the sheet material is carried in or out to or from the template, a terminal section of the sheet material is attracted and fixed on a sticking pad and, while air is ejected through the punching sections of the air table to make the sheet material in a float state, the sheet material is carried and moved.
